(19) United States
(12) Patent Application Publication
(10) Pub. No.: US 2010/0133858 A1
(43) Pub. Date: Jun. 3, 2010

(54) CARGO FLOOR HANDLE

(75) Inventor: Hardy HUCK, Ruesselsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/622,579

(22) Filed: Nov. 20, 2009

(30) Foreign Application Priority Data
Nov. 20, 2008 (DE) 102008058361.8

(51) Int. Cl. E05B 5/00; B62D 25/20

(52) U.S. Cl. 292/336.3; 296/184.1

(57) ABSTRACT

A cargo floor handle has a handle shell enclosing a grasping opening and a handling surface. The grasping opening is closed using a handle opening flap that is mounted so it is pivotable on the handle shell on a rotational axis.

### CROSS-REFERENCE TO RELATED APPLICATION

This application claims priority to German Patent Application No. 102008058361.8, filed Nov. 20, 2008, which is incorporated herein by reference in its entirety.

### TECHNICAL FIELD

The invention relates to a cargo floor handle, which has a handle shell, enclosing a grasping opening, having a handling surface and a cargo floor having a cargo floor handle in a motor vehicle for this purpose.

### BACKGROUND

Providing the luggage compartment or cargo space of passenger automobiles with a liftable cargo floor, which separates a storage or baggage space situated below the cargo floor from a cargo space or luggage compartment situated above the cargo floor, is known. The interior of the partitioned storage space can be accessed by lifting the cargo floor. The cargo floor can be a one-piece, rigid cargo floor, for example, which can be pivoted around a pivot axis which is situated essentially transversely to the vehicle longitudinal axis and thus to the travel direction of the motor vehicle. Of course, the cargo floor can also be pivotable transversely to the vehicle transverse axis and/or can comprise multiple pivot axes.

In order to allow lifting and pivoting of the cargo floor, equipping it with a reach-through opening which a user can grasp and reach through using his hand, is known from practice. Handle shells or recessed handles having handling surfaces implemented thereon are also known from practice, however, the user grasping in the handle shell or recessed handle using his hand and then being able to apply the traction necessary for pivoting the cargo floor using his fingers by grasping behind and below the handling surface. Finally, handle shells and recessed handles are also known in which a handling element is situated so it can be erected and folded out. The user can grasp this handling element, fold it out of the handle shell or recessed handle, and then apply the traction necessary for pivoting the cargo floor by engaging on the handling element.

The known cargo floor handles are distinguished by inadequate ergonomic quality. With the reach-through openings, on the one hand, there is a danger of injury when reaching in the openings, and, on the other hand, small parts may fall into the storage space below the cargo floor through the reach-through opening. The recessed handles provided with a closed floor have the disadvantage that it must be ensured that a sufficient engagement space is implemented, so that the fingers can grasp behind the handling surface. The cargo space handles which have fold-out handling elements situated in a recessed handle are connected to the disadvantage that the danger of pinching the fingers exists here.

The invention is based on at least one object of providing a cargo floor handle and a cargo floor of the type cited at the beginning, which is implemented in an ergonomically favorable way and is simple and practical to actuate. In addition, other objects, desirable features, and characteristics will become apparent from the subsequent summary and detailed description, taken in conjunction with the accompanying drawings and this background.

### SUMMARY

The object is achieved according to the invention for a cargo floor handle in that the engagement opening is closed using a handle opening flap, which is mounted so it is pivotable on a rotational axis on the handle shell.

The cargo floor handle according to an embodiment of the invention has a handle shell, which encloses a grasping opening, having an interior handling surface and a handle opening flap, which is mounted so it is pivotable on a rotational axis on the handle shell or on a frame which implements the handle shell. The handle opening flap closes the grasping opening of the handle shell in a way to be opened, which is in turn fastened in an opening of the cargo floor. In order to be able to grasp the cargo floor handle to raise the cargo floor, a user grasps in the grasping opening of the handle shell, whereby the handle opening flap, which is mounted so it is pivotable therein and closes the grasping opening, folds down out of its closure position toward the storage space, which is covered using the cargo floor. The fingers of the user thus receive sufficient movement play in the grasping opening and may grasp the handling surface and thus move the cargo floor.

In one embodiment, the handle opening flap is pivotable out of its closure position against the force of a spring. The handle opening flap closes the grasping opening and is held in its closure position by the spring loading. The handle opening flap must thus be moved out of its closure position by the user against the force of the spring, which is expediently performed in that when the hand is introduced into the grasping opening, the fingers press down the axially-mounted handle opening flap.

In order to ensure, after ending the actuation of the cargo floor handle, that the grasping opening recloses automatically, the spring preferably moves automatically into its closure position in the handle opening flap. The previously described cargo floor handle is implemented in an ergonomically favorable manner and is simple and practical to actuate and handle.

In the installed position of the cargo floor handle, the handle opening flap expediently presses against the handling surface on the cargo floor bottom side and accordingly may be folded down toward the vehicle floor. In this embodiment, the handle opening flap is positioned on the interior in the handle shell which frames the grasping opening in its closure position and presses against the handling surface for the fingertips, which is implemented on the interior bottom side of the handle shell. The handle opening flap advantageously forms the floor of the handle shell.

The cargo floor handle may be designed particularly ergonomically if the handle shell and the handle opening flap implement a recessed handle. It is particularly advantageous according to a further embodiment of the invention if the handle shell is implemented anatomically.

In order that the handle shell and the handle opening flap are producible with cost-effective manufacturing and in a less technically complex way, the handle shell and the handle opening flap preferably comprise plastic. Alternatively thereto, the handle shell and/or the handle opening flap are manufactured from a light metal. In addition to stability which is increased relative to plastic, this offers a relatively high degree of design freedom.

In order that the handle opening flap may be pivoted and folded out sufficiently far toward the vehicle floor into the inner space situated below the cargo floor, the cargo floor handle is expediently inserted in an opening of the cargo floor.

It is obvious that the above-mentioned features and the features to be explained hereafter are usable not only in the particular specified combination, but rather also in other combinations. The scope of the invention is only defined by the claims.

### BRIEF DESCRIPTION OF THE DRAWINGS

The present invention will hereinafter be described in conjunction with the following drawing figures, wherein like numerals denote like elements, and:

FIG. 1 shows a schematic illustration of a cargo floor handle according to an embodiment of the invention in its non-actuated idle position;

FIG. 2 shows a schematic illustration of the cargo floor handle according to FIG. 1 in an actuation position; and

FIG. 3 shows a further schematic illustration of the ergonomically shaped cargo floor handle.

### DETAILED DESCRIPTION

The following detailed description is merely exemplary in nature and is not intended to limit application and uses. Furthermore, there is no intention to be bound by any theory presented in the preceding background or summary or the following detailed description.

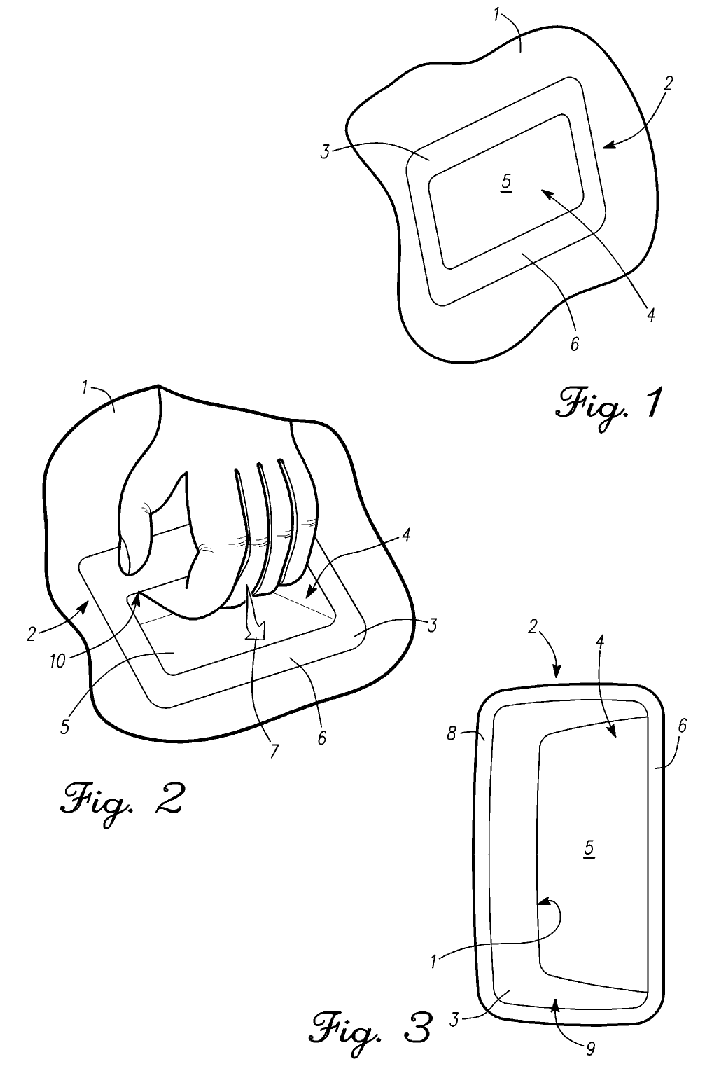

The cargo floor handle 2, which is situated in a cargo floor 1, essentially comprises a handle shell 3, which encloses a grasping opening 4. In the idle position of the cargo floor handle 2, the grasping opening 4 is closed using a handle opening flap 5. The handle opening flap 5 is mounted so it is pivotable on the longitudinal side 6 of the handle shell 3 downward out of the plane of the drawing on a rotational axis (not shown). The idle position of the cargo floor handle 2 shown in FIG. 1 represents its installed position in the cargo floor 1, a storage or baggage space being located on the opening side of the handle opening flap 5, which is shown in FIG. 2, below the cargo floor 1. The handle opening flap 5 presses from the bottom side against a handling surface 10, which is grasped by the fingers of the hand of a user and is implemented on the handle shell 3. The handle opening flap 5 is mounted on the rotational axis with a spring force applied, the spring force being set and oriented so that the handle opening flap 5 is held in the idle and closure position when no external forces act thereon.

To use and actuate the cargo floor handle 2, a user grasps using a hand in the grasping opening 4 and presses down the handle opening flap 5 against the force of the spring in the direction of the arrow 7 out of its closure position, so that the handle opening flap 5 is pivoted out of its closure position against the force of the spring. The grasping opening 4 is thus exposed and the fingers, in particular the fingertips, may engage behind and grasp the handling surface. In this position, the cargo floor 1 equipped with the cargo floor handle 2 can be raised by the user. After ending the actuation procedure, the user pulls his hand back out of the grasping opening 4, upon which the handle opening flap 5 pivots back automatically into its closure position driven by the force of the spring and occupies the idle position. The cargo floor handle 2 is inserted into an opening or a cutout of the cargo floor 1 and the handle opening flap 5 forms the floor of the handle shell 3.

According to FIG. 3, the cargo floor handle 2 has a peripheral frame 8, which is inserted precisely fitted in a reach-through opening implemented in the cargo floor 1. The handle shell 3 or a recessed handle 9, which is slightly curved and protrudes upward, is implemented on three sides on the interior. On the interior, the handle shell 3 delimits the grasping opening 4, which is closed by the handle opening flap 5. The handle opening flap 5 is pivotable on the longitudinal side 6 of the peripheral frame 8 around the rotational axis against the spring force in the direction of the arrow 7 shown in FIG. 2 out of its closure position—downward into its installed position in the cargo floor 1. According to FIG. 3, the handle shell 3 is shaped so that its inner side facing toward the handle opening flap 5 is implemented as the handling surface 10. The function is the same as was explained in connection with FIG. 2. The cargo floor handle 2 according to FIG. 3 is distinguished by a particularly good ergonomic design, its mode of operation being immediately situationally comprehensible in a self-explanatory way to a user without further explanations.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A cargo floor handle, comprising:
a grasping opening having a handling surface;
a handle shell framing the grasping opening; and
a handle opening flap adapted to close the grasping opening and pivotably mounted on the handle shell on a rotational axis.

2. The cargo floor handle according to claim 1, wherein the handle opening flap is pivotable out of a closure position against a force of a spring.

3. The cargo floor handle according to claim 2, wherein the spring automatically moves the handle opening flap into the closure position.

4. The cargo floor handle according to claim 1, wherein the handle opening flap presses against the handling surface on a cargo floor bottom side in an installed position of the cargo floor handle.

5. The cargo floor handle according to claim 1, wherein the handle opening flap implements a floor of the handle shell.

6. The cargo floor handle according to claim 1, wherein the handle shell and the handle opening flap form a recessed handle.

7. The cargo floor handle according to claim 1, wherein the handle shell is anatomically formed.

8. The cargo floor handle according to claim 1, wherein the handle shell and the handle opening flap comprise plastic.

9. The cargo floor handle according to claim 1, wherein the handle shell is manufactured from a light metal.

10. The cargo floor handle according to claim 1, wherein the handle opening flap are manufactured from a light metal.

11. The cargo floor handle according to claim 1, wherein the cargo floor handle is inserted into an opening of a cargo floor.

12. A motor vehicle, comprising:
a cargo floor; and
a cargo floor handle adapted for the cargo floor, the cargo floor handle, comprising: for the cargo floor handle comprising:
a grasping opening having a handling surface;
a handle shell framing the grasping opening; and
a handle opening flap adapted to close the grasping opening and pivotably mounted on the handle shell on a rotational axis.

13. The cargo floor handle according to claim 12, wherein the handle opening flap is pivotable out of a closure position against a force of a spring.

14. The cargo floor handle according to claim 13, wherein the spring automatically moves the handle opening flap into the closure position.

15. The cargo floor handle according to claim 12, wherein the handle opening flap presses against the handling surface on a cargo floor bottom side in an installed position of the cargo floor handle.

16. The cargo floor handle according to claim 12, wherein the handle opening flap implements a floor of the handle shell.

17. The cargo floor handle according to claim 12, wherein the handle shell and the handle opening flap form a recessed handle.

18. The cargo floor handle according to claim 12, wherein the handle shell is anatomically formed.

19. The cargo floor handle according to claim 12, wherein the handle shell and the handle opening flap comprise plastic.

20. The cargo floor handle according to claim 12, wherein the cargo floor handle is inserted into an opening of the cargo floor.
